(19) United States
(12) Patent Application Publication
(10) Pub. No.: US 2026/0185435 A1
(43) Pub. Date: Jul. 2, 2026

(54) TECHNIQUES FOR ENHANCING HYDRAULIC FRACTURING INJECTIVITY

(71) Applicant: Schlumberger Technology Corporation, Sugar Land, TX (US)

(72) Inventors: Abdul Muqtadir Khan, Sugar Land, TX (US); Murtaza Ziauddin, Sugar Land, TX (US); Taner Batmaz, Doha (QA); Konstantin Vidma, Sugar Land, TX (US); Haithem Abdelmoumene Segmane, Hassi Messaoud (DZ); Abdurauf M Kh Ben Sulaiman, Tripoli (LY); Christopher S. Daeffler, Sugar Land, TX (US); Philippe Enkababian, Doha (QA); Ziyad Alayouri, Awjilah (LY)

(21) Appl. No.: 19/367,584

(22) Filed: Oct. 23, 2025

Related U.S. Application Data
(60) Provisional application No. 63/740,365, filed on Dec. 31, 2024.

(51) Int. Cl. E21B 43/27; C09K 8/72; E21B 43/26

(52) U.S. Cl. CPC E21B 43/27; C09K 8/72; E21B 43/2607

(57) ABSTRACT

The present disclosure provides a method for treating a subterranean formation, may include injecting a treatment fluid into the subterranean formation, the treatment fluid including at least one of an inorganic acid or an organic acid, at least one of hydrofluoric acid or hydrofluoric acid precursor, and a precipitate inhibitor, and after injecting the treatment fluid into the subterranean formation, performing at least one of a fracturing treatment or a stimulation treatment. The inorganic acid includes at least one of hydrochloric acid or methanesulfonic acid. The treatment fluid can further include a blend of organic acids including at least one of citric acid, acetic acid, formic acid, or lactic acid. The hydrofluoric acid precursor includes at least one of ammonium bifluoride or ammonium fluoride. The precipitate inhibitor prevents precipitation of calcium fluoride and magnesium fluoride. The treatment fluid can be pumped in a single step without requiring a preflush treatment.

### BACKGROUND

Cancellation of fracturing stages due to high pressure is a common occurrence in clastic tight gas horizontal wells, which reduces the productive area across the lateral and drastically reduces the return on investment of the wells. Conventional techniques involve pumping a pre-treatment hydrochloric acid (HCl), hydrofluoric acid (HF), or mud acid batch as a rock breakdown acid to enhance the injectivity index. However, HCl creates damaging byproducts upon reaction with sandstone rock, with clay fractions in the formation, specifically illite and chlorite, generating insoluble precipitates while reacting with HCl at high temperatures. HF or mud acid, even though more suitable for sandstone rock formations, require pumping with pre-flush and post-flush steps, which is not straightforward when the objective of the well is to pump proppant fracturing and the acid treatment is just contingency. If not done correctly, besides the primary dissolution reaction that is desired, the secondary and tertiary reactions can generate precipitates that can negatively affect proppant placement and cause near-wellbore bridging. Accordingly, improvements are needed to overcome such challenges to these conventional solutions.

### SUMMARY

According to an aspect of the present disclosure, a method for treating a subterranean formation is provided. The method includes injecting a treatment fluid into the subterranean formation. The treatment fluid includes an acid including at least one of an inorganic acid or an organic acid, at least one of hydrofluoric acid or hydrofluoric acid precursor, and a precipitate inhibitor. The method further includes, after injecting the treatment fluid into the subterranean formation, performing at least one of a fracturing treatment or a stimulation treatment.

According to other aspects of the present disclosure, the method may include one or more of the following features. The method may further include, immediately before injecting the treatment fluid into the subterranean formation, performing a pump injection test using at least one of brine or water. The treatment fluid may further include a blend of organic acids, which may include at least one of citric acid, formic acid, acetic acid, or lactic acid. The blend of organic acids may include a chelant. The inorganic acid may include at least one of hydrochloric acid or methanesulfonic acid. The hydrofluoric acid precursor may include at least one of ammonium bifluoride or ammonium fluoride. The subterranean formation may include a horizontal well completed in two or more stages including a fracturing treatment and a matrix acidizing treatment.

According to another aspect of the present disclosure, a method for completing a horizontal well in a subterranean formation is provided. The method includes evaluating an injectivity of the horizontal well. The method includes determining if the injectivity is sufficient for a proppant placement. The method includes injecting, before performing the proppant placement, a single stage sandstone acid system into the well. The single stage acid system includes an inorganic acid, a precipitate inhibitor, and a blend of organic acids. The method includes performing at least one of a proppant fracturing treatment or a matrix acidizing treatment based on an injectivity response to the single stage sandstone acid system.

According to other aspects of the present disclosure, the method may include one or more of the following features. The single stage sandstone acid system may further include at least one of a hydrofluoric acid or a hydrofluoric acid precursor. The hydrofluoric acid precursor may include at least one of ammonium bifluoride or ammonium fluoride. The single stage sandstone acid system may be configured to enhance injectivity and prevent precipitation. The blend of organic acids may include at least one of citric acid, acetic acid, formic acid, or lactic acid. The method may further include perforating the horizontal well, and evaluating the injectivity of the horizontal well may include performing a pump injection test with at least one of brine or water after the perforating. When the injectivity is determined to not be sufficient for the proppant placement, the single stage sandstone acid system may be injected without requiring a preflush treatment.

According to another aspect of the present disclosure, a composition for treating a subterranean formation is provided. The composition includes an inorganic acid, at least one of hydrofluoric acid or hydrofluoric acid precursor, a precipitate inhibitor configured to prevent precipitation of calcium fluoride and magnesium fluoride, and a blend of organic acids configured to control primary, secondary, and tertiary reactions in the subterranean formation.

According to other aspects of the present disclosure, the composition may include one or more of the following features. The blend of organic acids may include at least one of citric acid, acetic acid, formic acid, or lactic acid. The blend of organic acids may include a chelant. The inorganic acid may include at least one of hydrochloric acid or methanesulfonic acid. The composition may further include ammonium chloride. The composition may be configured to be pumped in a single step without requiring a preflush treatment. The hydrofluoric acid precursor may include at least one of ammonium bifluoride or ammonium fluoride.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF FIGURES

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 shows an example of a perforation system for forming perforations in a wellbore;

FIG. 2 shows a core flow test comparison with Bandera Gray cores at 300° F., in accordance with embodiments of the present disclosure; and

FIG. 3 shows a workflow method for a hybrid completion technique using proppant, acid, or both, according to aspects of the present disclosure.

### DETAILED DESCRIPTION

Embodiments of the present disclosure relate the treatment of subterranean formations using single stage acid systems. In particular, embodiments of the present disclosure relate to a single stage sandstone acid (SSA) system for enhancing injectivity in subterranean formations. The SSA system may be formulated to address challenges associated with conventional acid treatments used in hydraulic fracturing operations. In some embodiments, the SSA system may be designed to overcome limitations of traditional hydrochloric acid (HCl) treatments that can create damaging byproducts when reacting with sandstone rock formations. The SSA system may also provide advantages over hydrofluoric acid (HF) or mud acid treatments that typically require complex pre-flush and post-flush procedures.

The SSA system may include a blend of scale inhibitor with organic acids to control primary, secondary, and tertiary reactions that can occur during acid treatment of sandstone formations. In some embodiments, organic acids may be used to slow reaction rates and provide solutions for acid-sensitive clay minerals present in the formation. The system may be tailored for pretreatment applications in proppant fracturing treatments because the SSA system can be pumped in a single step without requiring preflush treatments. This single-step approach may reduce operational complexity and eliminate risks of precipitation that can occur with multi-step acid treatment procedures.

In some embodiments, the SSA system may be formulated to prevent formation of insoluble precipitates that can occur when conventional acids react with clay fractions in the formation, such as illite and chlorite minerals. The system may be designed to enhance injectivity index, which may be defined as the ratio of pumping pressure to injection rate. Enhanced injectivity may allow for improved proppant placement during fracturing operations and may reduce the likelihood of stage cancellation due to high injection pressures. The SSA system may be particularly suitable for use in clastic tight gas horizontal wells where low injectivity can limit the effectiveness of fracturing treatments.

The SSA system may be configured to work in conjunction with hybrid completion strategies that combine proppant fracturing and sandstone acidizing techniques. In some embodiments, the system may be used as a contingency treatment when initial injectivity testing indicates insufficient injection rates for effective proppant placement. The SSA system may provide flexibility in completion operations by allowing operators to adjust treatment approaches based on real-time injectivity measurements. This adaptive approach may help maximize the productive area across horizontal well laterals and improve return on investment for well completion operations.

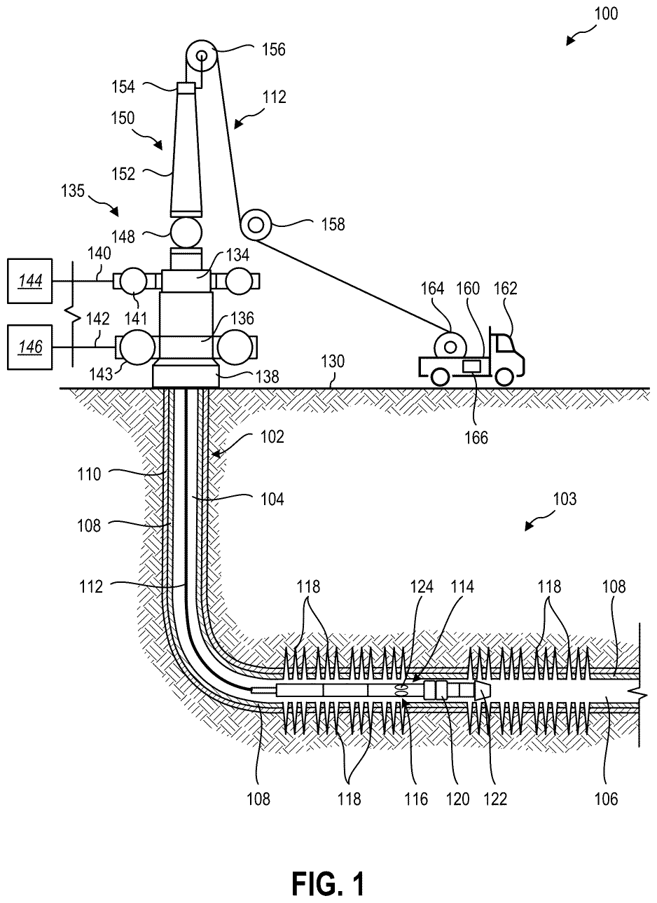

Referring to FIG. 1, a perforation system 100 may be configured for forming perforations in a wellbore 102 and an earth formation 103 through which the wellbore 102 extends. The perforation system 100 may provide a means for creating openings that facilitate fluid communication between the wellbore 102 and surrounding geological structures. The earth formation 103 may include various rock types and geological layers that contain hydrocarbons or other subsurface fluids. The wellbore 102 may be formed through drilling operations that penetrate the earth formation 103 to access hydrocarbon-bearing zones at various depths and orientations. The perforation system 100 may be utilized in conjunction with the SSA system to enhance injectivity and improve completion operations in challenging formations.

The wellbore 102 may include a vertical portion 104 and a horizontal portion 106 that extends laterally through the earth formation 103. The vertical portion 104 may extend downward from the surface through multiple geological layers, while the horizontal portion 106 may be oriented substantially parallel to bedding planes or other geological features within the earth formation 103. This configuration may allow for enhanced contact with hydrocarbon-bearing zones and may improve production efficiency. The transition between the vertical portion 104 and the horizontal portion 106 may occur at various depths depending on the target formation characteristics and drilling objectives. In some embodiments, the horizontal portion 106 may be particularly suitable for application of the SSA system due to the potential for low injectivity conditions that can occur in horizontal well completions.

The wellbore 102 may be lined with a casing 108 that provides structural integrity and isolation between different zones within the earth formation 103. The casing 108 may include steel tubulars or other materials that resist corrosion and maintain wellbore stability under downhole conditions. The casing 108 may extend through both the vertical portion 104 and the horizontal portion 106, providing a continuous barrier between the wellbore fluids and the surrounding earth formation 103. Multiple casing strings of different diameters may be installed at various depths to accommodate different operational requirements and formation characteristics. A cement 110 may be positioned in an annular space between the casing 108 and the earth formation 103 to provide zonal isolation and structural support. The cement 110 may include Portland cement or other cementing materials that cure to form a solid barrier that prevents fluid migration between different zones within the earth formation 103.

As further shown in FIG. 1, a wireline 112 may extend into the wellbore 102 to convey downhole equipment and facilitate various wellbore operations. The wireline 112 may include one or more electrical cables configured to transmit data and signals to downhole components, enabling real-time communication and control during operations. The wireline 112 may include a protective sheath or jacket disposed around internal portions to provide protection against wellbore fluids and mechanical wear. In some embodiments, the wireline 112 may include a steel wire armored cable that provides structural strength and electrical conductivity for downhole operations. The protective sheath may be formed of fluid-resistant materials such as epoxy compounds that resist degradation from exposure to various wellbore fluids and chemicals, including the SSA system components.

The wireline 112 may carry a bottomhole assembly 114 that includes various tools and components for performing downhole operations within the wellbore 102. The bottomhole assembly 114 may be configured to perform multiple functions during a single trip into the wellbore 102, thereby improving operational efficiency and reducing the time for completion activities. The bottomhole assembly 114 may include components that are selectively activated or operated based on downhole conditions or surface commands transmitted through the wireline 112. In some embodiments, the bottomhole assembly 114 may be positioned at predetermined locations within the wellbore 102 using depth control systems that monitor the position of the assembly relative to target zones within the earth formation 103. The bottomhole assembly 114 may facilitate the creation of perforations that enable subsequent injection of the SSA system into the formation.

With continued reference to FIG. 1, the bottomhole assembly 114 may include a perforating gun 116 configured to create openings through the casing 108 and cement 110 to establish fluid communication with the earth formation 103. The perforating gun 116 may contain shaped charges that are designed to penetrate through multiple barriers including the casing 108, the cement 110, and portions of the earth formation 103 surrounding the wellbore 102. The perforating gun 116 may be configured to fire the shaped charges at predetermined locations along the wellbore 102 to create perforations 118 that extend from the wellbore 102 into the earth formation 103. The perforations 118 may provide pathways for fluid communication between the wellbore 102 and hydrocarbon-bearing zones within the earth formation 103, enabling the flow of formation fluids into the wellbore 102 for production or the injection of treatment fluids such as the SSA system into the formation. The perforating gun 116 may include spaced perforations 124 through which the shaped charges are discharged into the casing 108 and surrounding materials, with the spaced perforations 124 positioned at predetermined intervals along the length of the perforating gun 116 to provide controlled placement of the shaped charges.

The bottomhole assembly 114 may further include a plug setting tool 120 configured to place a plug 122 within the wellbore 102 to provide zonal isolation during completion operations. The plug setting tool 120 may be designed to transport the plug 122 to a predetermined location within the wellbore 102 and deploy the plug 122 to create a seal against the inner surface of the casing 108. The plug 122 may include expandable elements that engage with the casing 108 to prevent fluid flow past the plug 122 location. In some embodiments, the plug 122 may include sealing elements such as elastomeric packers that conform to the inner surface of the casing 108 to provide effective sealing under downhole pressure and temperature conditions. The plug setting tool 120 may include mechanisms for expanding the plug 122 and securing the plug 122 in position within the wellbore 102. The plug 122 may be positioned to isolate previously perforated sections of the wellbore 102 from subsequent completion operations, enabling staged treatment approaches where the SSA system may be applied to specific intervals independently.

At a surface 130, the wellbore 102 may be equipped with various control systems and equipment that facilitate fluid injection and production operations. A fluid flow control system 135 may be positioned at the surface 130 to direct and control the flow of treatment fluids into the wellbore 102 and to manage the flow of formation fluids out of the wellbore 102 during production operations. The fluid flow control system 135 may include multiple components including flow control valves, spools, flow crosses, and fittings that work together to provide operational control over fluid movement. A first flow control device 134 and a second flow control device 136 may be incorporated within the fluid flow control system 135 to provide selective control over different fluid streams or operational modes. The first flow control device 134 and the second flow control device 136 may each include valve assemblies that can be opened or closed to permit or prevent fluid flow through designated pathways. The fluid flow control system 135 may be coupled to a wellhead 138 that terminates the wellbore 102 at the surface 130 and provides a connection point for various surface equipment and fluid handling systems. A first fluid conduit 140 may be connected to the first flow control device 134 through a first valve 141 to enable selective fluid communication between external fluid sources and the wellbore 102, while a second fluid conduit 142 may be connected to the second flow control device 136 through a second valve 143 to provide an additional pathway for fluid delivery or to enable simultaneous injection of different fluid types.

A first pump 144 may be operatively connected to the first fluid conduit 140 to provide the pressure and flow rate needed to deliver fluids through the first flow control device 134 and into the wellbore 102. A second pump 146 may be operatively connected to the second fluid conduit 142 to provide independent pumping capability for fluids delivered through the second flow control device 136. The first pump 144 and the second pump 146 may be configured to operate at different pressures and flow rates to accommodate various operational requirements including fracturing operations that may utilize the SSA system. A sealing assembly 150 may be operatively coupled to the fluid flow control system 135 to provide sealing around the wireline 112 during deployment, conveyance, intervention, and other wellsite operations performed while the wireline 112 extends within the wellbore 102. The sealing assembly 150 may include a lock chamber 152 that functions as a lubricator, airlock, or riser to enable safe insertion and removal of downhole equipment under pressure conditions. A stuffing box 154 may be configured within the sealing assembly 150 to create a seal around the outer surface of the wireline 112, while a pulley 156 may be positioned to guide the wireline 112 into the stuffing box 154. A guide pulley 158 may direct the wireline 112 between the pulley 156 and a conveyance device 160 such as a winch system that controls the movement of the wireline 112 within the wellbore 102. The wireline 112 may be supplied from a drum 164 that may be carried by a vehicle 162 along with the conveyance device 160, where the drum 164 may be rotated by an actuator 166 that may include an electric motor, hydraulic motor, or other means for selectively unwinding and winding the wireline 112 around the drum 164 while applying adjustable tensile forces to control the position and movement of the bottomhole assembly 114 within the wellbore 102.

The treatment fluid used in systems such as the perforation system 100 shown in FIG. 1 may include several core components that work together to provide enhanced injectivity and controlled reaction characteristics in sandstone formations. The treatment fluid may include an inorganic acid that serves as a primary dissolution agent for mineral components within the formation. In some embodiments, the inorganic acid may include hydrochloric acid, methanesulfonic acid, or both. The inorganic acid may be present at concentrations of between about 10% and about 50%, for example between about 20% and about 40%, or for example between about 30% and about 40%. In one embodiment, the inorganic acid may be present at a concentration of about 36% in the treatment fluid system, which may provide sufficient dissolution capacity while maintaining system stability. The concentration of the inorganic acid may be selected to balance dissolution effectiveness with the prevention of damaging byproducts that can occur with higher acid concentrations.

The treatment fluid may further include at least one of hydrofluoric acid or a hydrofluoric acid precursor that may be configured to solubilize aluminosilicate minerals present in clay formation, for example in sandstone formations. In some embodiments, the hydrofluoric acid precursor may include ammonium bifluoride, ammonium fluoride, or both. The hydrofluoric acid precursor may provide controlled release of hydrofluoric acid under downhole conditions, which may allow for more predictable reaction kinetics compared to direct hydrofluoric acid injection. The hydrofluoric acid or hydrofluoric acid precursor may be particularly effective for dissolving clay minerals and other aluminosilicate components that can contribute to formation damage and reduced injectivity. The use of a hydrofluoric acid precursor may provide operational advantages by reducing handling risks associated with concentrated hydrofluoric acid while maintaining dissolution effectiveness.

In at least one embodiment, a precipitate inhibitor such as a scale inhibitor may be included in the treatment fluid to prevent precipitation of calcium fluoride and magnesium fluoride that can form during acid reactions with formation minerals. The precipitate inhibitor may be configured to prevent precipitation of calcium fluoride and magnesium fluoride by sequestering calcium and magnesium ions that are released during the dissolution of carbonate and other minerals in the formation. In some embodiments, the precipitate inhibitor may function by forming stable complexes with divalent cations, thereby preventing the formation of insoluble fluoride precipitates that could reduce formation permeability. The precipitate inhibitor may be selected to remain stable under the temperature and pressure conditions encountered in downhole environments while maintaining effectiveness throughout the duration of the acid treatment.

The treatment fluid may include a blend of organic acids that may be configured to control primary, secondary, and tertiary reactions in the subterranean formation. In some embodiments, the blend of organic acids may include at least one of citric acid, acetic acid, formic acid, or lactic acid. The blend of organic acids may provide controlled reaction kinetics that may reduce the formation of damaging precipitates while maintaining dissolution effectiveness. The organic acids may serve to buffer the pH of the treatment fluid and may provide chelating properties that help prevent the formation of insoluble reaction products. In some embodiments, the blend of organic acids may include a chelant that may provide additional metal ion sequestration capabilities. The chelant may function to bind metal ions that are released during mineral dissolution, thereby preventing the formation of secondary precipitates that could impair formation permeability.

In at least some embodiments, the treatment fluid may include ammonium chloride as an additional component beyond the core acid system components. Ammonium chloride may serve multiple functions within the treatment fluid, including providing buffering capacity and contributing to the overall ionic strength of the fluid. In some embodiments, ammonium chloride may help stabilize clay minerals within the formation by providing ammonium ions that can exchange with other cations in clay structures. The ammonium chloride may also contribute to the prevention of clay swelling that can occur when formation clays contact aqueous treatment fluids. The inclusion of ammonium chloride may enhance the overall effectiveness of the treatment fluid by providing additional mechanisms for formation stabilization and damage prevention.

The combination of these core components may provide a treatment fluid that can be injected in a single stage without requiring preflush or postflush treatments. The synergistic effects of the inorganic acid, hydrofluoric acid or precursor, precipitate inhibitor, and blend of organic acids may provide controlled dissolution of formation minerals while preventing the formation of damaging precipitates. The treatment fluid formulation may be designed to maintain stability under a wide range of downhole conditions while providing predictable reaction characteristics that enhance injectivity without causing formation damage. The balanced composition may allow for effective treatment of sandstone formations with varying mineralogy and clay content.

The treatment fluid may support the addition of various compatible additives that enhance the performance and operational characteristics of the acid system. In some embodiments, mutual solvents may be incorporated into the treatment fluid to improve the solubility of organic components and enhance the overall stability of the fluid system. The mutual solvents may facilitate the dissolution of hydrocarbon residues and other organic materials that may be present in the formation, thereby improving the effectiveness of the acid treatment. Mutual solvents may be added at concentrations up to 150 gallons per 1,000 gallons of treatment fluid, depending on the specific operational requirements and formation characteristics. The inclusion of mutual solvents may also help prevent the formation of emulsions that could interfere with the acid treatment process.

Corrosion inhibitors may be incorporated into the treatment fluid as functional components to protect downhole equipment and tubulars from acid-induced corrosion. In some embodiments, corrosion inhibitors may be selected based on the specific metallurgy of the downhole equipment and the temperature and pressure conditions expected during the treatment. The corrosion inhibitors may function by forming protective films on metal surfaces or by neutralizing corrosive species in the treatment fluid. Multiple types of corrosion inhibitors may be used in combination to provide comprehensive protection against different corrosion mechanisms. Corrosion inhibitors may be added at concentrations ranging from 5 to 20 gallons per 1,000 gallons of treatment fluid, with the specific concentration determined based on the severity of the corrosive environment and the duration of the treatment.

Fines migration control agents may be included in the treatment fluid as compatible additives for controlling the movement of formation fines that may be mobilized during the acid treatment process. In some embodiments, fines migration control agents may function by stabilizing clay particles and other fine materials within the formation, preventing these materials from migrating and potentially plugging pore spaces or production pathways. The fines migration control agents may be particularly beneficial in formations with high clay content or formations that are susceptible to fines production during fluid injection. Fines migration control agents may be added at concentrations up to 2 gallons per 1,000 gallons of treatment fluid, with the concentration adjusted based on the clay content and mineralogy of the target formation.

Iron control agents may be incorporated into the treatment fluid as functional components for managing iron-related issues that may arise during acid treatment operations. In some embodiments, iron control agents may function by chelating iron ions that are released during the dissolution of iron-bearing minerals in the formation or that may be present in the treatment fluid due to corrosion of downhole equipment. The iron control agents may prevent the precipitation of iron hydroxides or iron sulfides that could reduce formation permeability or interfere with subsequent treatment operations. Iron control agents may be particularly beneficial in formations with high iron content or in situations where iron contamination of the treatment fluid is a concern. Iron control agents may be added at concentrations up to 50 pounds per 1,000 gallons of treatment fluid, with the specific concentration determined based on the expected iron content and the duration of the treatment.

Non-emulsifying agents may be included in the treatment fluid as compatible additives to prevent emulsion formation between the acid system and hydrocarbon fluids that may be present in the formation. In some embodiments, non-emulsifying agents may function by reducing the interfacial tension between aqueous and hydrocarbon phases, thereby preventing the formation of stable emulsions that could impair fluid flow or interfere with the acid treatment process. The non-emulsifying agents may be particularly beneficial in formations with high oil saturation or in situations where emulsion formation has been observed in previous treatments. Non-emulsifying agents may be added at concentrations up to 5 gallons per 1,000 gallons of treatment fluid, with the concentration adjusted based on the hydrocarbon content of the formation and the potential for emulsion formation.

Surfactants may be incorporated into the treatment fluid as functional components that can enhance wetting characteristics and improve fluid distribution within the formation. In some embodiments, surfactants may function by reducing surface tension and improving the ability of the treatment fluid to penetrate into tight pore spaces and microfractures within the formation. The surfactants may also help prevent the formation of water blocks that could impair hydrocarbon flow after the treatment is completed. Surfactants may be selected based on their compatibility with the acid system and their stability under downhole temperature and pressure conditions. Surfactants may be added at concentrations up to 5 gallons per 1,000 gallons of treatment fluid, with the specific type and concentration selected based on the formation characteristics and treatment objectives.

H₂S scavengers may be included in the treatment fluid as compatible additives for managing hydrogen sulfide that may be generated during acid reactions with sulfur-bearing minerals in the formation. In some embodiments, H₂S scavengers may function by chemically binding hydrogen sulfide molecules, thereby preventing the accumulation of this toxic and corrosive gas during treatment operations. The H₂S scavengers may be particularly beneficial in formations known to contain pyrite, marcasite, or other sulfur-bearing minerals that can react with acid to produce hydrogen sulfide. H₂S scavengers may be added at concentrations up to 5 gallons per 1,000 gallons of treatment fluid, with the concentration determined based on the sulfur content of the formation and the potential for hydrogen sulfide generation.

In at least one embodiment, the treatment fluid may be formulated using specific ratios with defined amounts of each component per 1,000 gallons of fluid to ensure consistent performance and predictable results. In some embodiments, the formulation ratios may be established based on laboratory testing and field experience to optimize the balance between dissolution effectiveness, reaction control, and operational safety. The specific formulation ratios may vary depending on the formation characteristics, temperature conditions, and treatment objectives, but may typically include defined ranges for each component to maintain system stability and effectiveness. For example, a standard formulation may include 860 gallons of water and additives, 250.4 pounds of ammonium chloride, 83.5 pounds of ammonium bifluoride, 417.3 pounds of citric acid, 41.3 gallons of lactic acid, 3.5 gallons of scale inhibitor, and 56.0 gallons of 36% hydrochloric acid per 1,000 gallons of treatment fluid. Alternative formulations may be developed for different temperature ranges or formation types, with adjustments made to the component ratios to optimize performance under specific conditions.

The treatment fluid may be evaluated through core flow testing methodologies that provide quantitative assessment of dissolution effectiveness and permeability enhancement under controlled laboratory conditions. In some embodiments, core flow testing may be performed using standardized core samples that represent the mineralogy and petrophysical properties of target sandstone formations. The core flow testing methodology may involve the use of Bandera Gray sandstone cores, which may provide consistent baseline properties for comparative evaluation of different acid systems. The testing procedure may include initial permeability measurements, followed by acid injection at controlled flow rates and pressures, and subsequent permeability measurements to determine the effectiveness of the treatment. Core flow testing may be conducted at elevated temperatures to simulate downhole conditions and provide realistic performance data for field applications.

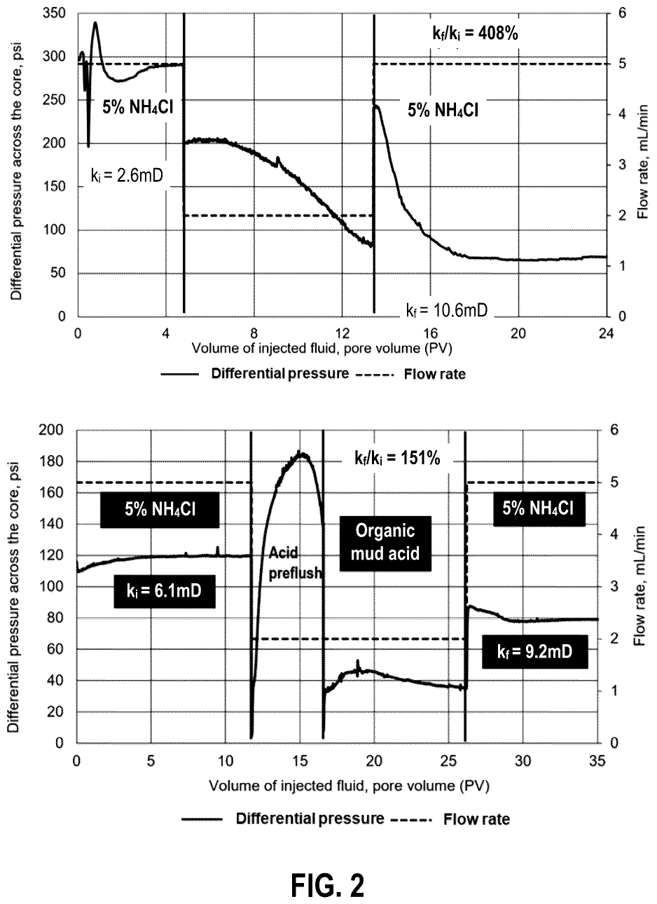

Referring to FIG. 2, core flow test results may demonstrate the performance advantages of the single stage sandstone acid system compared to conventional acid treatment approaches. The core flow testing may be performed at 300° F. to evaluate the effectiveness of the treatment fluid under elevated temperature conditions that may be encountered in downhole environments. The testing temperature of 300° F. may be selected to represent typical reservoir conditions where thermal effects on acid reactions and mineral dissolution become significant factors in treatment performance. The elevated temperature testing may provide insights into the stability and effectiveness of the treatment fluid components under conditions that may cause conventional acid systems to generate damaging precipitates or lose dissolution effectiveness.

The core flow test comparison may reveal substantial performance differences between the single stage sandstone acid system and conventional treatment approaches. In some embodiments, the single stage sandstone acid system may achieve regained permeability of 408% when tested with Bandera Gray cores at 300° F., demonstrating substantial enhancement of formation permeability through controlled mineral dissolution. The regained permeability measurement may represent the ratio of final core permeability to initial core permeability, expressed as a percentage, with values above 100% indicating net permeability enhancement. The 408% regained permeability result may indicate that the treatment fluid can increase formation permeability by more than four times the original value, providing substantial improvement in fluid flow capacity through the treated formation.

As further shown in FIG. 2, conventional acid treatment systems may achieve significantly lower performance under identical testing conditions. The conventional system shown on the lower plot in FIG. 2, which may include 10% formic acid as preflush followed by 9/1 organic mud acid, may achieve regained permeability of 151% under the same testing conditions with Bandera Gray cores at 300° F. The lower performance of the conventional system may be attributed to the formation of secondary precipitates during the multi-step treatment process or incomplete dissolution of formation minerals due to suboptimal reaction kinetics. The conventional treatment approach may require preflush steps that add operational complexity while failing to provide the controlled reaction environment achieved by the single stage sandstone acid system.

In contrast, as shown by the upper plot in FIG. 2, the SSA system described herein may result in a regained permeability of 408% without a preflush and using the fluid treatments including the single stage acid systems described herein. The performance comparison shown in FIG. 2 is one non-limiting example of formulations, values, and experimental components. The fluid treatment systems and regained permeability results are not necessarily limited to those shown in the example of FIG. 2. Rather, those shown in FIG. 2 illustrate one representative set of parameters and the resulting advantages.

The performance comparison may demonstrate that the single stage sandstone acid system provides superior stimulation effectiveness without requiring preflush treatments that add operational complexity and potential failure points. The elimination of preflush requirements may reduce the risk of incompatible fluid interactions and may simplify field operations while achieving enhanced performance results. The core flow testing results may indicate that the balanced formulation of the single stage sandstone acid system provides more effective mineral dissolution and permeability enhancement than conventional approaches that rely on sequential treatment steps. The testing methodology may provide validation of the treatment fluid effectiveness under controlled conditions that can be correlated with field performance expectations.

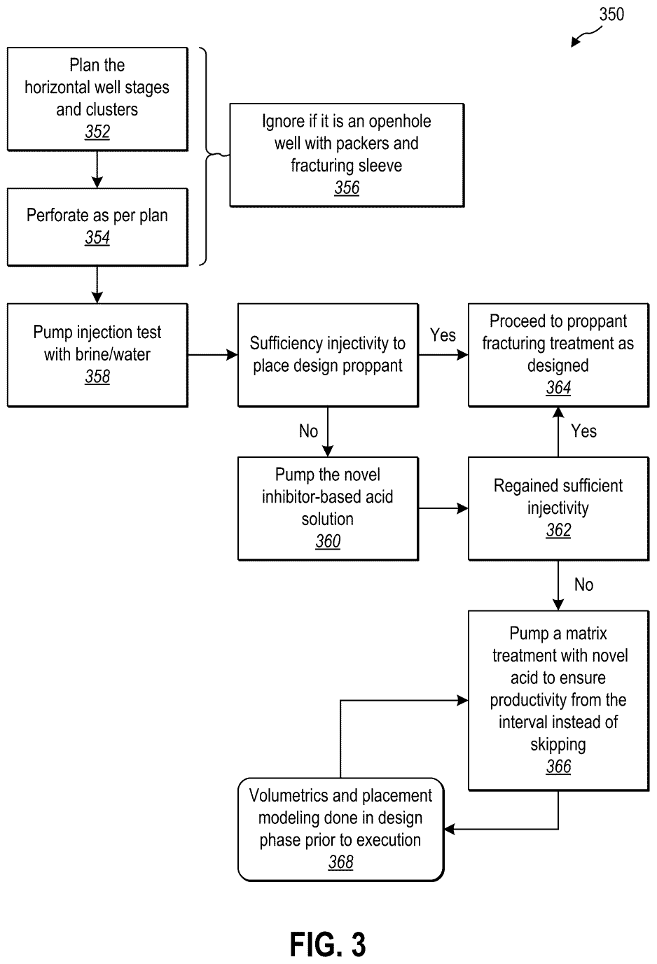

Referring to FIG. 3, a method 350 may be implemented for hybrid completion operations that combine proppant fracturing and sandstone acidizing techniques based on formation injectivity conditions. The method 350 may provide a systematic approach for evaluating formation characteristics and selecting appropriate treatment strategies to maximize well productivity while minimizing operational risks. The method 350 may be designed to address challenges associated with low injectivity conditions that can occur in horizontal well completions, particularly in clastic tight gas formations where conventional fracturing approaches may encounter high injection pressures or stage cancellation issues. The hybrid completion strategy may enable operators to adapt treatment approaches based on real-time formation response measurements, thereby optimizing completion effectiveness across varying formation conditions. The method 350 may incorporate contingency planning procedures that allow for rapid implementation of alternative treatment strategies when initial injectivity testing indicates suboptimal conditions for conventional proppant placement operations.

The method 350 may begin with a step 352 of planning horizontal well stages and clusters, which may involve detailed geological and engineering analysis to determine optimal perforation placement and treatment design parameters. The step 352 may include evaluation of formation characteristics, reservoir properties, and completion objectives to establish baseline treatment parameters for each stage along the horizontal wellbore 102. The planning process may involve preparation of contingency volumetrics and designs for each stage during the design phase, allowing operators to have predetermined treatment alternatives available for implementation based on actual formation response during operations. The contingency planning approach may include development of multiple treatment scenarios, including conventional proppant fracturing, hybrid treatments combining acid pretreatment with proppant placement, and matrix acidizing treatments using the single stage sandstone acid system. The step 352 may also involve coordination with surface equipment capabilities and operational logistics to ensure that all planned treatment options can be executed efficiently during field operations.

Following the planning phase, the method 350 may proceed to a step 354 of perforating the horizontal well according to the predetermined plan established during the step 352. The step 354 may involve deployment of the perforating gun 116 within the bottomhole assembly 114 to create the perforations 118 through the casing 108 and cement 110 at specified locations along the horizontal portion 106 of the wellbore 102. The perforating operations may be conducted using the wireline 112 and associated surface equipment including the fluid flow control system 135 to maintain wellbore pressure control during perforation creation. The step 354 may include verification of perforation placement and quality through various measurement techniques to ensure that adequate communication pathways have been established between the wellbore 102 and the earth formation 103. The perforating process may be designed to create optimal perforation geometry and distribution to facilitate subsequent injectivity testing and treatment fluid placement operations.

In at least some embodiments of the method 350, such as at a step 356, the perforating step for openhole wells with packers and fracturing sleeves may be ignored, recognizing that alternative completion configurations may not require conventional perforation operations. In openhole completion scenarios, the method 350 may proceed directly to subsequent steps without requiring perforation operations, thereby streamlining the completion process for wells that utilize alternative isolation and stimulation techniques.

As further shown in FIG. 3, the method 350 may include a step 358 of performing a pump injection test with brine or water to evaluate the injectivity characteristics of the formation following perforation operations. The step 358 may involve injection of test fluids through the first pump 144 and first fluid conduit 140 to measure formation response under controlled injection conditions. The pump injection test may provide quantitative data regarding formation injectivity, including injection pressure, flow rate relationships, and pressure buildup characteristics that indicate formation permeability and damage conditions. The step 358 may be conducted immediately after perforating operations to establish baseline injectivity measurements before implementing treatment operations. The pump injection testing procedure may involve injection of brine or water at incrementally increasing rates to determine the maximum sustainable injection rate and identify any pressure limitations that could affect subsequent treatment operations.

Following the pump injection test, the method 350 may evaluate whether sufficient injectivity exists for effective proppant placement operations based on predetermined criteria established during the planning phase. The injectivity evaluation may involve comparison of measured injection parameters with design requirements for proppant fracturing treatments, including minimum flow rates, maximum allowable pressures, and pressure stability characteristics. The evaluation process may consider formation-specific factors such as fracture initiation pressure, fracture propagation characteristics, and proppant transport requirements to determine treatment feasibility. When the injectivity evaluation indicates sufficient formation response for proppant placement, the method 350 may proceed along a pathway toward conventional fracturing treatment implementation.

When sufficient injectivity is determined to exist for proppant placement operations, the method 350 may proceed to a step 364 of performing proppant fracturing treatment as designed during the initial planning phase. The step 364 may involve implementation of conventional hydraulic fracturing procedures using proppant-laden fluids injected through the second pump 146 and second fluid conduit 142 to create and prop open fractures within the earth formation 103. The proppant fracturing treatment may be conducted according to predetermined design parameters including fluid volumes, proppant concentrations, injection rates, and treatment pressures established during the step 352. The step 364 may utilize the surface equipment including the wellhead 138, fluid flow control system 135, and associated pumping systems to deliver treatment fluids at the required pressures and flow rates for effective fracture creation and proppant placement. The fracturing treatment implementation may include real-time monitoring of treatment parameters to ensure optimal fracture development and proppant distribution throughout the created fracture network.

When the injectivity evaluation indicates insufficient formation response for effective proppant placement, the method 350 may proceed to a step 360 of pumping an SSA system to enhance formation injectivity characteristics. The step 360 may involve injection of the treatment fluid described herein, for example an SSA system treatment fluid containing the inorganic acid, precipitate inhibitor, and blend of organic acids through the first pump 144 to dissolve formation minerals and remove near-wellbore damage that may be limiting injectivity. The SSA described herein systems may be injected without requiring preflush treatment, thereby simplifying operational procedures while providing controlled dissolution of formation components that contribute to injectivity impairment. The step 360 may be implemented using bullheading techniques at lower injection rates when stable pressure conditions are achieved, allowing for effective acid placement even under challenging injectivity conditions. The acid injection process may be monitored through pressure and flow rate measurements to assess formation response and determine treatment effectiveness in real-time.

Following acid injection during the step 360, the method 350 may proceed to a step 362 of evaluating whether sufficient injectivity has been regained through the acid treatment process. The step 362 may involve conducting additional pump injection testing using procedures similar to those implemented during the step 358 to quantify changes in formation injectivity characteristics resulting from the acid treatment. The injectivity evaluation may include comparison of pre-treatment and post-treatment injection parameters to determine the effectiveness of the SSA system in enhancing formation permeability and reducing injection pressures. The step 362 may utilize predetermined criteria for injectivity improvement to determine whether subsequent proppant fracturing operations can be successfully implemented. The evaluation process may consider both immediate injectivity improvements and longer-term formation response characteristics to ensure sustainable treatment effectiveness.

When the step 362 indicates that sufficient injectivity has been regained through acid treatment, the method 350 may return to the step 364 for implementation of proppant fracturing treatment using the enhanced injectivity conditions created by the acid pretreatment. The return pathway may enable the method 350 to achieve the original treatment objectives through a hybrid approach that combines acid stimulation with conventional fracturing techniques. The enhanced injectivity conditions may allow for more effective proppant placement and fracture development compared to conditions that would have existed without acid pretreatment. The hybrid treatment approach may provide improved fracture geometry, enhanced proppant distribution, and better overall stimulation effectiveness compared to either acid treatment or fracturing treatment implemented independently. The integration of acid pretreatment with subsequent fracturing operations may optimize formation contact and maximize productive capacity from the treated interval.

When the step 362 indicates that sufficient injectivity has not been regained through the initial acid treatment, the method 350 may proceed to a step 366 of pumping a matrix treatment with the SSA system to ensure productivity from the interval rather than abandoning the stage. The step 366 may involve injection of larger volumes of the treatment fluid to achieve more extensive dissolution of formation minerals and removal of damage throughout the critical matrix surrounding the wellbore 102. The matrix acidizing treatment may be designed to enhance formation permeability through controlled dissolution reactions while preventing the formation of damaging precipitates that could further impair formation productivity. The step 366 may represent a matrix acidizing treatment approach that focuses on near-wellbore stimulation rather than fracture creation, providing an alternative pathway for enhancing well productivity when conventional fracturing approaches are not feasible. The matrix treatment implementation may utilize specialized injection procedures and fluid volumes optimized for deep acid penetration and effective mineral dissolution throughout the formation matrix.

The method 350 may include a step 368 indicating that volumetrics and placement modeling are conducted during the design phase prior to field execution, ensuring that all treatment options have been properly engineered and validated before implementation. The step 368 may emphasize the importance of comprehensive pre-job planning that includes detailed analysis of formation characteristics, treatment fluid requirements, and operational procedures for each potential treatment scenario. The design phase activities may include laboratory testing, numerical modeling, and operational planning to optimize treatment effectiveness and minimize operational risks during field implementation. The step 368 may ensure that operators have access to validated treatment designs and operational procedures for rapid implementation of alternative treatment strategies based on real-time formation response measurements. The comprehensive planning approach may enable efficient field operations while maintaining flexibility to adapt treatment strategies based on actual formation conditions encountered during completion operations.

The treatment method for subterranean formations may involve a systematic approach that begins with injection of the treatment fluid followed by implementation of fracturing or stimulation treatments based on formation response characteristics. In some embodiments, the treatment method may be designed to address injectivity challenges that can occur in sandstone formations, particularly in horizontal wells where conventional acid treatments may create damaging precipitates or require complex multi-step procedures. The treatment method may utilize the SSA system to provide controlled dissolution of formation minerals while maintaining operational simplicity through elimination of preflush requirements. The method may be implemented using surface pumping equipment and downhole delivery systems that enable precise control of treatment fluid placement and injection parameters. The treatment approach may provide flexibility for operators to adapt completion strategies based on real-time formation response measurements and injectivity conditions encountered during operations.

The single-step pumping approach may provide substantial operational advantages compared to conventional acid treatment methods that require preflush and postflush procedures. In some embodiments, the elimination of preflush treatments may reduce operational complexity, minimize the risk of incompatible fluid interactions, and decrease the total treatment time required for completion operations. The single-step approach may be enabled by the balanced formulation of the treatment fluid, which may include scale inhibitors and organic acid blends that prevent precipitation reactions that typically necessitate preflush treatments in conventional systems. The treatment fluid composition may be designed to maintain stability and effectiveness when injected directly into formation fluids without requiring displacement or conditioning steps. The single-step methodology may reduce the number of fluid interfaces and chemical interactions that can occur during multi-step treatments, thereby minimizing the potential for formation damage or treatment effectiveness degradation.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combined with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for treating a subterranean formation, comprising:
injecting a treatment fluid into the subterranean formation, the treatment fluid comprising:
an acid comprising at least one of an organic acid or an inorganic acid;
at least one of hydrofluoric acid or hydrofluoric acid precursor; and
a precipitate inhibitor; and
after injecting the treatment fluid into the subterranean formation, performing at least one of a fracturing treatment or a stimulation treatment.

2. The method of claim 1, further comprising, immediately before injecting the treatment fluid into the subterranean formation, performing a pump injection test using at least one of brine or water.

3. The method of claim 1, wherein the treatment fluid further comprises a blend of organic acids including at least one of citric acid, formic acid, acetic acid, or lactic acid.

4. The method of claim 3, wherein the blend of organic acids comprises a chelant.

5. The method of claim 1, wherein the inorganic acid comprises at least one of hydrochloric acid or methanesulfonic acid.

6. The method of claim 1, wherein the hydrofluoric acid precursor comprises at least one of ammonium bifluoride or ammonium fluoride.

7. The method of claim 1, wherein the subterranean formation comprises a horizontal well completed in two or more stages comprising:
the fracturing treatment; and
a matrix acidizing treatment.

8. A method for completing a horizontal well in a subterranean formation, comprising:
evaluating an injectivity of the horizontal well;
determining if the injectivity is sufficient for a proppant placement;
injecting, before performing the proppant placement, a single stage acid system into the horizontal well, the single stage acid system comprising:
an inorganic acid;
a precipitate inhibitor; and
a blend of organic acids; and
performing at least one of a proppant fracturing treatment or a matrix acidizing treatment based on an injectivity response to the single stage acid system.

9. The method of claim 8, wherein the single stage acid system further comprises at least one of:
a hydrofluoric acid; or
a hydrofluoric acid precursor, comprising at least one of:
ammonium bifluoride; or
ammonium fluoride.

10. The method of claim 9, wherein the single stage acid system is configured to enhance the injectivity and prevent precipitation.

11. The method of claim 8, wherein the blend of organic acids comprises at least one of citric acid, acetic acid, formic acid, or lactic acid.

12. The method of claim 8, further comprising:
perforating the horizontal well; and
evaluating the injectivity of the horizontal well comprises performing a pump injection test with at least one of brine or water after the perforating.

13. The method of claim 12, wherein, when the injectivity is determined to not be sufficient for the proppant placement, the single stage acid system is injected without requiring a preflush treatment.

14. A composition for treating a subterranean formation, comprising:
an inorganic acid;
at least one of hydrofluoric acid or hydrofluoric acid precursor;
a precipitate inhibitor configured to prevent precipitation of calcium fluoride and magnesium fluoride; and
a blend of organic acids configured to control primary, secondary, and tertiary reactions in the subterranean formation.

15. The composition of claim 14, wherein the blend of organic acids comprises at least one of citric acid, acetic acid, formic acid, or lactic acid.

16. The composition of claim 15, wherein the blend of organic acids comprises a chelant.

17. The composition of claim 14, wherein the inorganic acid comprises at least one of hydrochloric acid or methanesulfonic acid.

18. The composition of claim 14, further comprising ammonium chloride.

19. The composition of claim 18, wherein the composition is configured to be pumped in a single step without requiring a preflush treatment.

20. The composition of claim 14, wherein the hydrofluoric acid precursor comprises at least one of ammonium bifluoride or ammonium fluoride.
